(19) United States
(12) Patent Application Publication
(10) Pub. No.: US 2018/0309314 A1
(43) Pub. Date: Oct. 25, 2018

(54) WIRELESS POWER TRANSFER PROTECTION

(71) Applicant: QUALCOMM Incorporated, San Diego, CA (US)

(72) Inventors: Mark WHITE, II, San Diego, CA (US); Cody WHEELAND, San Diego, CA (US); William Henry VON NOVAK, III, San Diego, CA (US); Joseph MAALOUF, San Diego, CA (US)

(21) Appl. No.: 15/495,127

(22) Filed: Apr. 24, 2017

(51) Int. Cl. H02J 7/02; H02J 7/00; H02J 50/12; H02J 50/40; H02J 50/80

(52) U.S. Cl. CPC H02J 7/025; H02J 7/0029; H02J 50/80; H02J 50/40; H02J 50/12

(57) ABSTRACT

Disclosed are methods, devices, systems, apparatus, media, and other implementations, including a method for wireless power transfer that includes operating a wireless power receiver in a default protection state in which charging or powering of a load coupled to the wireless power receiver is inhibited except upon detection of one or more safety charging conditions for safely charging the wireless power receiver, determining that a safety charging condition, of the one or more safety charging conditions, is met, and operating the wireless power receiver in a charging state at least in part in response to determining that the safety charging condition, of the one or more safety conditions, is met, with the wireless power receiver powering or charging the load while in the charging state and receiving power.

### TECHNICAL FIELD

The disclosure relates generally to wireless power delivery to electronic devices, and in particular to protecting wireless power transfer devices.

### BACKGROUND

An increasing number and variety of electronic devices are powered via rechargeable batteries. Such devices include mobile phones, portable music players, laptop computers, tablet computers, computer peripheral devices, communication devices (e.g., BLUETOOTH devices), digital cameras, hearing aids, and the like. While battery technology has improved, battery-powered electronic devices increasingly require and consume greater amounts of power. As such, these devices frequently require recharging. Rechargeable devices are often charged via wired connections that require cables or other similar connectors that are physically connected to a power supply. Cables and similar connectors may sometimes be inconvenient or cumbersome and have other drawbacks. Wireless power charging systems may allow users to charge and/or power electronic devices without physical, electro-mechanical connections, thus simplifying the use of the electronic devices.

Examples of electronic devices for which wireless power charging implementation are suitable are implantable medical devices such as medical implants (e.g., medical neuromodulation implants, which are small devices that attach to nerves and allow both monitoring and stimulation of nerves, insulin level monitors, insulin pumps, and pacemakers, etc.) Although power for implant devices may be provided via a battery, this could be risky as such batteries would require periodic replacement, and thus require regular surgeries. In wireless power charging implementations for implantable medical devices, communication between each implant receiver and the power transmitter is important in order to ensure that the receiver is charging at an appropriate voltage level.

There are several ways in which an implant device's wireless power receiver (also referred to as a power receiving unit, or PRU) can be damaged. For example, exposing the implant (or some other types of electronic devices) to an uncontrolled magnetic field (e.g., a magnetic field from an incompatible or unpaired transmitter, another person's implant charger, a malfunctioning implant charger, cross-connected devices, an implant without communications, etc.) can damage the device. Typical forms of protection like OVP (over-voltage protection), OCP (over-current protection), and OTP (over-temperature protection) are often activated as a last resort when operating conditions exceed safe levels.

### SUMMARY

An example method for wireless power transfer includes: operating a wireless power receiver in a default protection state in which charging or powering of a load coupled to the wireless power receiver is inhibited except upon detection of one or more safety charging conditions for safely charging the wireless power receiver; determining that a safety charging condition, of the one or more safety charging conditions, is met; and operating the wireless power receiver in a charging state at least in part in response to determining that the safety charging condition, of the one or more safety conditions, is met, the wireless power receiver powering or charging the load while in the charging state and receiving power.

An example wireless power receiver includes: a detection circuit configured to determine that a safety charging condition is met and to produce a charge control signal in response to determining that the safety charging condition is met; and a charging circuit, communicatively coupled to the detection circuit and to a load, and configured to power or charge the load using wirelessly transferred power, the charging circuit configured to operate in a charging state in response to receiving the charge control signal, and in the absence of receiving the charge control signal to operate in a default protection state in which powering or charging of the load is inhibited.

An example apparatus for wireless power transfer includes: means for operating a wireless power receiver in a default protection state in which charging or powering of a load coupled to the wireless power receiver is inhibited except upon detection of one or more safety charging conditions for safely charging the wireless power receiver; means for determining that a safety charging condition, of the one or more safety charging conditions, is met; and means for operating the wireless power receiver in a charging state at least in part in response to determining that the safety charging condition, of the one or more safety conditions, is met, the wireless power receiver powering or charging the load while in the charging state and receiving power.

Example non-transitory computer readable media is provided, programmed with instructions, executable on a processor, to: operate a wireless power receiver in a default protection state in which charging or powering of a load coupled to the wireless power receiver is inhibited except upon detection of one or more safety charging conditions for safely charging the wireless power receiver; determine that a safety charging condition, of the one or more safety charging conditions, is met; and operate the wireless power receiver in a charging state at least in part in response to determining that the safety charging condition, of the one or more safety conditions, is met, the wireless power receiver powering or charging the load while in the charging state and receiving power.

The following detailed description and accompanying drawings provide a better understanding of the nature and advantages of the disclosure.

### BRIEF DESCRIPTION OF THE DRAWINGS

Drawing elements that are common among the following figures may be identified using the same reference numerals.

With respect to the discussion to follow and in particular to the drawings, the particulars shown represent examples for purposes of illustrative discussion, and are presented in the cause of providing a description of principles and conceptual aspects of the disclosure. In this regard, no attempt is made to show implementation details beyond what is needed for a fundamental understanding of the disclosure. The discussion to follow, in conjunction with the drawings, makes apparent to those of skill in the art how embodiments in accordance with the disclosure may be practiced.

FIG. 1 is a functional block diagram of an example of a wireless power transfer system.

FIG. 2 is a functional block diagram of an example of another wireless power transfer system.

FIG. 3 is a schematic diagram of an example of a portion of transmit circuitry or receive circuitry of the system shown in FIG. 2.

FIG. 4 is a functional block diagram of an example wireless power transfer system.

FIG. 5A is a circuit diagram of an example circuit implementation to facilitate control of state transitions for a wireless power receiver.

FIG. 5B is a circuit diagram of another example circuit implementation to facilitate control of state transitions for a wireless power receiver.

FIG. 6 is a flowchart of an example wireless power transfer procedure.

FIG. 7 is a flowchart of another example wireless power transfer procedure.

FIG. 8 is a flowchart of another example wireless power transfer procedure with threshold detection and in-band signature detection.

FIG. 9 is a flowchart of an example procedure to switch a wireless power receiver from a charging state to a protection state.

### DETAILED DESCRIPTION

To protect a wireless power receiver (also referred to as power receiving unit, or PRU) from extraneous magnetic fields (e.g., in situations in which the wireless power receiver may be one of multiple wireless power receivers and wireless power transmitters operating in a wireless power transfer ecosystem, and in which the respective magnetic fields of individual devices may need to be adjusted without harming other devices), the wireless power receiver is defaulted into a protection mode, and subsequently, upon detecting one or more different stimuli/triggers/conditions, the wireless power receiver can exit the default protection mode (to allow wireless charging). Some examples of triggers to pull the PRU out of protection mode include: 1) an in-band voltage/current signal that commands the wireless power receiver out of protection mode, 2) a threshold induced voltage, and/or 3) an out-of-band radio frequency (RF) communication signal that commands the wireless power receiver out of protection mode. Additionally, when the wireless power receiver is in charging state/mode (e.g., after earlier exiting protection state), the wireless power receiver may enter (or re-enter) protection mode in response to various triggers/stimuli. Examples of triggers to cause the wireless power receiver to go into protection mode include: 1) detecting RF communications (such as Bluetooth-Low-Energy™, or some other short-range or long-range communication protocol) that are associated with transmitters that are incompatible, or not approved for use, with the wireless power receiver, and could generate harmful magnetic fields, 2) detecting an induced voltage or current at the wireless power receiver that is not accompanied with a communication message (e.g., an in-band or out-of-band communication message that identifies the transmitting source as one that is compatible, or approved for use, with the wireless power receiver), 3) determining that the wireless power receiver is at a ‘low battery’ level.

Thus, disclosed herein are devices, circuits, systems, methods, and other implementations, including a method for wireless power transfer that includes operating a wireless power receiver (e.g., of an implantable medical device) in a default protection state, in which charging or powering of a load coupled to the wireless power receiver is inhibited, except upon detection of one or more safety charging conditions for safely charging the wireless power receiver (i.e., operating the wireless power receiver in the default protection state occurs in the absence of determining that at least one charging condition is met). The method further includes determining that a safety charging condition, of the one or more safety charging conditions, is met (e.g., that a voltage/current level wirelessly induced at the wireless power receiver is maintained between some voltage/current range for some specified time duration), and operating the wireless power receiver in a charging state at least in part in response to determining that the safety charging condition is met, with the wireless power receiver powering or charging the load while in the charging state and receiving power. Also disclosed herein are implementations that include a wireless power receiver that includes a detection circuit configured to determine that a safety charging condition is met and to produce a charge control signal in response to determining that the safety charging condition is met, and a charging circuit, communicatively coupled to the detection circuit and to a load, and configured to power or charge the load using wirelessly transferred power, with the charging circuit configured to operate in a charging state in response to receiving the charge control signal, and in the absence of receiving the charge control signal to operate in a default protection state in which powering or charging of the load is inhibited.

Wireless power transfer may refer to transferring any form of energy associated with electric fields, magnetic fields, electromagnetic fields, or otherwise from a transmitter to a receiver without physical electrical conductors attached to and connecting the transmitter to the receiver to deliver the power (e.g., power may be transferred through free space). The power output into a wireless field (e.g., a magnetic field or an electromagnetic field) may be received, captured by, or coupled to by a power receiving element to achieve power transfer. The transmitter transfers power to the receiver through a wireless coupling of the transmitter and receiver.

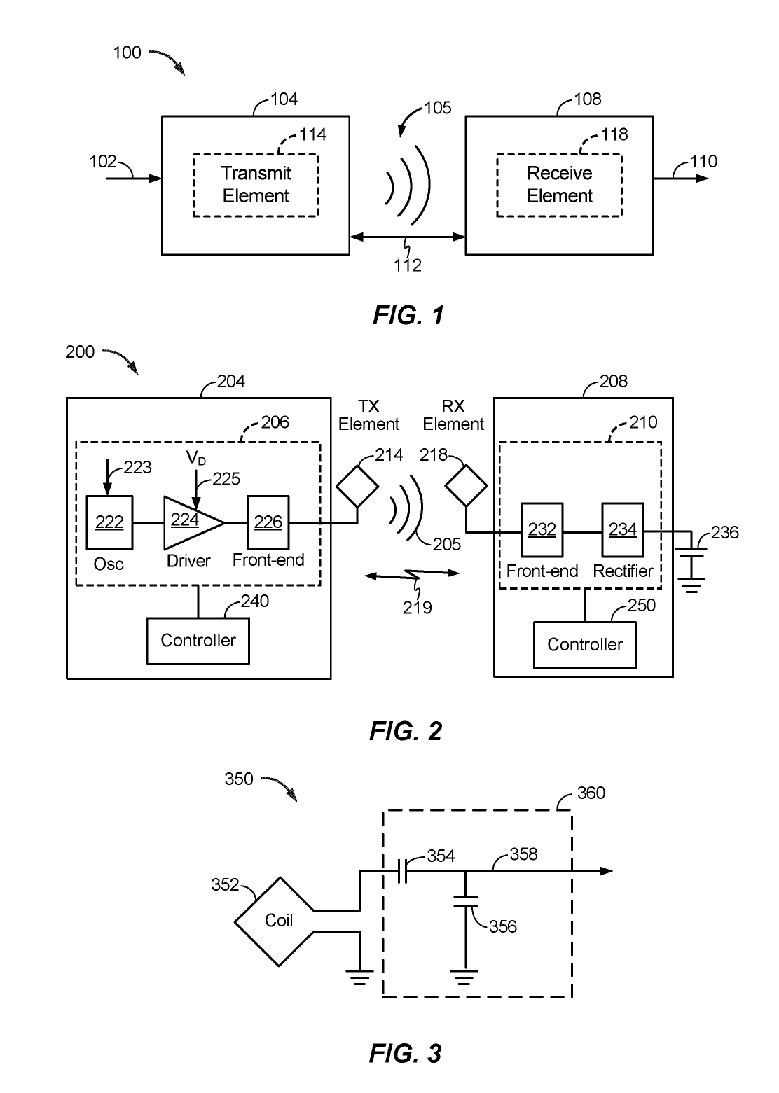

FIG. 1 is a functional block diagram of an example of a wireless power transfer system 100. Input power 102 may be provided to a transmitter 104 (sometimes referred to as a power transmitting unit, or PTU) from a power source (not shown in this figure) to generate a wireless (e.g., magnetic or electromagnetic) field 105 for performing energy transfer. A receiver 108 (also referred to as a wireless power receiver, or power receiving unit (PRU)) may couple to the wireless field 105 and generate output power 110 for storage or consumption by a device (not shown in this figure) that is coupled to receive the output power 110. The transmitter 104 and the receiver 108 are separated by a non-zero distance 112. The transmitter 104 includes a power transmitting element 114 configured to transmit/couple energy to the receiver 108. The receiver 108 includes a power receiving element 118 configured to receive or capture/couple energy transmitted from the transmitter 104.

The transmitter 104 and the receiver 108 may be configured according to a mutual resonant relationship. When the resonant frequency of the receiver 108 and the resonant frequency of the transmitter 104 are substantially the same, transmission losses between the transmitter 104 and the receiver 108 are reduced compared to the resonant frequencies not being substantially the same. As such, wireless power transfer may be provided over larger distances when the resonant frequencies are substantially the same. Resonant inductive coupling techniques allow for improved efficiency and power transfer over various distances and with a variety of inductive power transmitting and receiving element configurations.

The wireless field 105 may correspond to the near field of the transmitter 104. The near field corresponds to a region in which there are strong reactive fields resulting from currents and charges in the power transmitting element 114 that do not significantly radiate power away from the power transmitting element 114. The near field may correspond to a region that up to about one wavelength, of the power transmitting element 114. Efficient energy transfer may occur by coupling a large portion of the energy in the wireless field 105 to the power receiving element 118 rather than propagating most of the energy in an electromagnetic wave to the far field.

The transmitter 104 may output a time-varying magnetic (or electromagnetic) field with a frequency corresponding to the resonant frequency of the power transmitting element 114. When the receiver 108 is within the wireless field 105, the time-varying magnetic (or electromagnetic) field may induce a current in the power receiving element 118. As described above, with the power receiving element 118 configured as a resonant circuit to resonate at the frequency of the power transmitting element 114, energy may be efficiently transferred. An alternating current (AC) signal induced in the power receiving element 118 may be rectified to produce a direct current (DC) signal that may be provided to charge an energy storage device (e.g., a battery) or to power a load.

FIG. 2 is a functional block diagram of an example of a wireless power transfer system 200. The system 200 includes a transmitter 204 and a receiver 208. The transmitter 204 (which may also be referred to as a wireless power transmitter, a PTU, a remote charging device, etc.) is configured to provide power to a power transmitting element 214 that is configured to transmit power wirelessly to a power receiving element 218 that is configured to receive power from the power transmitting element 214 and to provide power to the receiver 208. Despite their names, the power transmitting element 214 and the power receiving element 218, being passive elements, may transmit and receive power and communications.

The transmitter 204 includes the power transmitting element 214, transmit circuitry 206 that includes an oscillator 222, a driver circuit 224, and a front-end circuit 226. The power transmitting element 214 is shown outside the transmitter 204 to facilitate illustration of wireless power transfer using the power receiving element 218. The oscillator 222 may be configured to generate an oscillator signal at a desired frequency that may adjust in response to a frequency control signal 223. The oscillator 222 may provide the oscillator signal to the driver circuit 224. The driver circuit 224 may be configured to drive the power transmitting element 214 at, for example, a resonant frequency of the power transmitting element 214 based on an input voltage signal (VD) 225. The driver circuit 224 may be a switching amplifier configured to receive a square wave from the oscillator 222 and output a sine wave.

The front-end circuit 226 may include a filter circuit configured to filter out harmonics or other unwanted frequencies. The front-end circuit 226 may include a matching circuit configured to match the impedance of the transmitter 204 to the impedance of the power transmitting element 214. As will be explained in more detail below, the front-end circuit 226 may include a tuning circuit to create a resonant circuit with the power transmitting element 214. As a result of driving the power transmitting element 214, the power transmitting element 214 may generate a wireless field 205 to wirelessly output power at a level sufficient for charging a battery 236, or powering a load.

The transmitter 204 further includes a controller 240 operably coupled to the transmit circuitry 206 and configured to control one or more aspects of the transmit circuitry 206, or accomplish other operations relevant to managing the transfer of power. The controller 240 may be a micro-controller or a processor. The controller 240 may be implemented as an application-specific integrated circuit (ASIC). The controller 240 may be operably connected, directly or indirectly, to each component of the transmit circuitry 206. The controller 240 may be further configured to receive information from each of the components of the transmit circuitry 206 and perform calculations based on the received information. The controller 240 may be configured to generate control signals (e.g., signal 223) for each of the components that may adjust the operation of that component. As such, the controller 240 may be configured to adjust or manage the power transfer based on a result of the operations performed by the controller 240. The transmitter 204 may further include a memory (not shown) configured to store data, for example, such as instructions for causing the controller 240 to perform particular functions, such as those related to management of wireless power transfer.

The receiver 208 includes the power receiving element 218, and receive circuitry 210 that includes a front-end circuit 232 and a rectifier circuit 234. The power receiving element 218 is shown outside the receiver 208 to facilitate illustration of wireless power transfer using the power receiving element 218. The front-end circuit 232 may include matching circuitry configured to match the impedance of the receive circuitry 210 to the impedance of the power receiving element 218. As will be explained below, the front-end circuit 232 may further include a tuning circuit to create a resonant circuit with the power receiving element 218. The rectifier circuit 234 may generate a DC power output from an AC power input to charge the battery 236, as shown in FIG. 3. The receiver 208 and the transmitter 204 may additionally communicate on a separate communication channel 219 (e.g., BLUETOOTH, ZIGBEE, cellular, etc.). The receiver 208 and the transmitter 204 may alternatively communicate via in-band signaling using characteristics of the wireless field 205.

The receiver 208 may be configured to determine whether an amount of power transmitted by the transmitter 204 and received by the receiver 208 is appropriate for charging the battery 236. The transmitter 204 may be configured to generate a predominantly non-radiative field with a direct field coupling coefficient (k) for providing energy transfer. The receiver 208 may directly couple to the wireless field 205 and may generate an output power for storing or consumption by a battery (or load) 236 coupled to the output or receive circuitry 210.

The receiver 208 further includes a controller 250 that may be configured similarly to the transmit controller 240 as described above for managing one or more aspects of the wireless power receiver 208. The receiver 208 may further include a memory (not shown) configured to store data, for example, such as instructions for causing the controller 250 to perform particular functions, such as those related to management of wireless power transfer.

As discussed above, transmitter 204 and receiver 208 may be separated by a distance and may be configured according to a mutual resonant relationship to try to minimize transmission losses between the transmitter 204 and the receiver 208.

FIG. 3 is a schematic diagram of an example of a portion of the transmit circuitry 206 or the receive circuitry 210 of FIG. 2. While a coil, and thus an inductive system, is shown in FIG. 3, other types of systems, such as capacitive systems for coupling power, may be used, with the coil replaced with an appropriate power transfer (e.g., transmit and/or receive) element. As illustrated in FIG. 3, transmit or receive circuitry 350 includes a power transmitting or receiving element 352 and a tuning circuit 360. The power transmitting or receiving element 352 may also be referred to or be configured as an antenna such as a “loop” antenna. The term “antenna” generally refers to a component that may wirelessly output energy for reception by another antenna and that may receive wireless energy from another antenna. The power transmitting or receiving element 352 may also be referred to herein or be configured as a “magnetic” antenna, such as an induction coil (as shown), a resonator, or a portion of a resonator. The power transmitting or receiving element 352 may also be referred to as a coil or resonator of a type that is configured to wirelessly output or receive power. As used herein, the power transmitting or receiving element 352 is an example of a “power transfer component” of a type that is configured to wirelessly output and/or receive power. The power transmitting or receiving element 352 may include an air core or a physical core such as a ferrite core (not shown).

When the power transmitting or receiving element 352 is configured as a resonant circuit or resonator with tuning circuit 360, the resonant frequency of the power transmitting or receiving element 352 may be based on the inductance and capacitance. Inductance may be simply the inductance created by a coil and/or other inductor forming the power transmitting or receiving element 352. Capacitance (e.g., a capacitor) may be provided by the tuning circuit 360 to create a resonant structure at a desired resonant frequency. As a non-limiting example, the tuning circuit 360 may comprise a capacitor 354 and a capacitor 356, which may be added to the transmit or receive circuitry 350 to create a resonant circuit.

The tuning circuit 360 may include other components to form a resonant circuit with the power transmitting or receiving element 352. As another non-limiting example, the tuning circuit 360 may include a capacitor (not shown) placed in parallel between the two terminals of the circuitry 350. Still other designs are possible. For example, the tuning circuit in the front-end circuit 226 may have the same design (e.g., 360) as the tuning circuit in the front-end circuit 232. Alternatively, the front-end circuit 226 may use a tuning circuit design different than in the front-end circuit 232.

For power transmitting elements, the signal 358, with a frequency that substantially corresponds to the resonant frequency of the power transmitting or receiving element 352, may be an input to the power transmitting or receiving element 352. For power receiving elements, the signal 358, with a frequency that substantially corresponds to the resonant frequency of the power transmitting or receiving element 352, may be an output from the power transmitting or receiving element 352. Although aspects disclosed herein may be generally directed to resonant wireless power transfer, aspects disclosed herein may be used in non-resonant implementations for wireless power transfer.

With reference again to FIG. 2, as noted, the wireless power receiver 208 includes a receive circuitry 210 that is used to process and transfer wirelessly transferred power to a load such a battery (e.g., a rechargeable battery) 236 (the receive circuitry may thus be part of a charging circuit). The wireless power receiver further includes the controller 250 configured to control the operation and functionality of the receive circuitry, including, as will be discussed in greater detail below, to operate the wireless power receiver 208 in a default protection mode in which charging or powering of the load 236 is inhibited except upon detection of one or more safety conditions for safely charging the wireless power receiver (e.g., detect and determine that one or more safety conditions for safely charging or powering the load are present), and in response to determining that a safety condition, from the one or more safety conditions, is met, the controller is configured to operate the wireless power receiver in a charging state (e.g., cause the charging circuit to be activated) to cause powering or charging of the load.

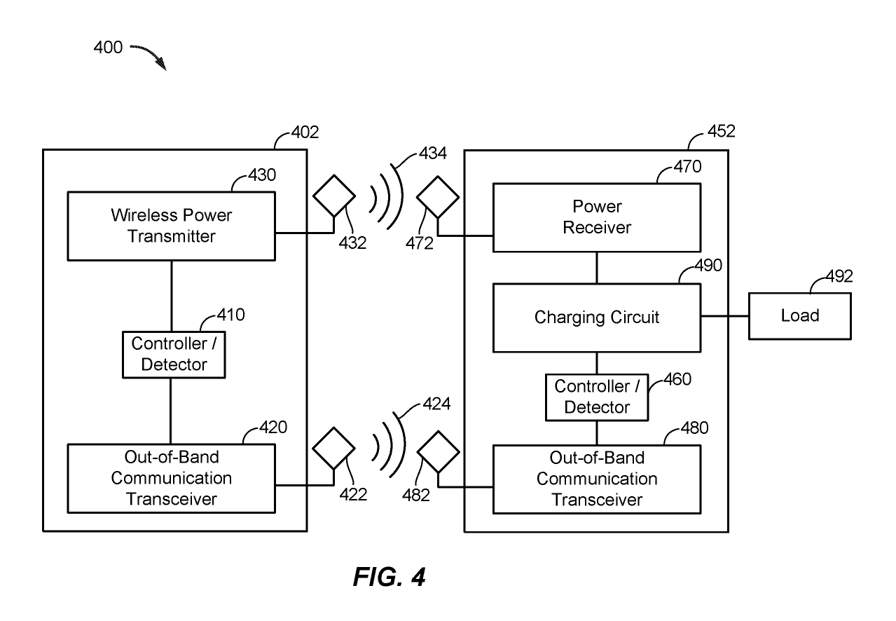

FIG. 4 is a schematic diagram of a wireless charging system 400, which may include at least some of the functionality and/or circuit implementations of the wireless power transfer systems 100, 200, or 300 depicted in FIGS. 1-3. The charging system 400 includes a charging device (a wireless power transmitter) 402, which may be similar to the transmitters 104 and 204 shown in FIGS. 1-2, and a wireless power receiver 452 (which may be similar to the receivers 108 and 208 of FIGS. 1-2) connected to a load 492 (e.g., a power storing device/unit such as a rechargeable battery). The charging device 402 may include a wireless power antenna 432 (which may be similar to the transmitting element 214 of FIG. 2) and a wireless power transmitter 430 (which may be similar to the transmit circuitry 206 of FIG. 2) coupled to the antenna 432, and configured to generate a wireless charging field 434 in at least one charging region. Wireless power transfer via the antenna 432 is performed over a frequency band, referred to as the in-band range, that preferably has the same resonant frequency as the charging device 402.

As also illustrated in FIG. 4, the charging device 402 can further include a communication antenna 422 and a transceiver 420 (e.g., an out-of-band communication transceiver), coupled to the communication antenna 422, and configured to communicate with the wireless power receiver 452 via the communication antenna 422 (shown in FIG. 4 as transmissions 424). The out-of-band frequency range used to communicate transmissions via the transceiver 420 and the antenna 422 corresponds to a different frequency band than the in-band range used for wireless power transfer through the wireless power transmitter 430 and the antenna 432. Although the in-band frequency range and out-of-band frequency range may have some overlap, the two frequency ranges are non-congruent, and generally the out-of-band frequency range does not include the resonant frequency for the charging device 402. The charging device 402 additionally includes a controller/detector 410, which may be similar to the controller 240 of FIG. 2, which is communicatively coupled to the wireless power transmitter 430 and the out-of-band communication transceiver 420, and is configured to control operation of the charging device 402, e.g., to cause wireless power transfer via the transmitter 430 and the antenna 432, to generate and transmit wireless communications either using the out-of-band communication transceiver 420 (e.g., according to some long-range or short-range communication protocol) or using the in-band range (e.g., by modulating wireless power signals transmitted via the transmitter 430 and the antenna 432 so that the transmitted signals include detectable data, such as some signature associated with the charging device 402), and other control operations.

With continued reference to FIG. 4, the wireless power receiver 452 may include a wireless power antenna 472, which may be similar to the power receiving element 218 of FIG. 2, configured to receive power from a wireless charger (e.g., the charging device 402) and a power receiver 470 coupled to the wireless power antenna 472.

The wireless power receiver 452 includes an out-of-band communication transceiver 480 coupled to a communication antenna 482. The out-of-band communication transceiver 480 is configured to receive communications (control signaling, data messages) from one or more remote devices (including from the charging device 402). Data received via the out-of-band transceiver 480 may indicate the identify of remote charging devices in the vicinity of the wireless power receiver 452, and may be used by the controller/detector 460 to determine whether one or more safety conditions (to safely power the load 492) exist or have been met (in which case, the wireless power receiver 452 may be pulled out of the default protection state). The controller/detector 460 may also be configured to determine whether unsafe conditions for powering of the load exist, for example whether unsafe conditions for powering the load 492 have emerged while the wireless power receiver 452 is currently powering the load 492. The controller/detector 460 may be configured to respond to determining that unsafe conditions exist by causing cessation of the charging operation and returning the wireless power receiver 452 to its default protection mode). Out-of-band communication protocols may include any protocols established by standards organizations such as IEEE, Infrared Data Association (IrDA), etc., and may include such communication protocols/technologies, as Wireless USB, Z-Wave, ZigBee, Bluetooth-Low-Energy™ (BLE), other types of short-range protocols, various wireless local area network (WLAN) protocols, wireless wide area network (WWAN) protocols, etc.

As noted, the controller/detector 460 (which may constitute part of a detection circuit) is configured to determine that a safety charging condition (or multiple safety conditions) is met, and if so to produce a charge control signal in response to determining that the safety charging condition is met. In such embodiments, a charging circuit (such as the charging circuit 490 and/or the power receiver 470), communicatively coupled to the detection circuit and to a load, is configured to operate in a charging state to cause powering/charging of the load using wirelessly transferred power in response to receiving the charge control signal (the charging circuit may be realized, at least in part, based on the receive circuitry 210 depicted in FIG. 2). In some embodiments, the controller/detector 460 configured to determine that the safety charging condition is met, may be configured to determine that a voltage level or a current level wirelessly induced at the wireless power receiver 452 is between a first (minimum) voltage/current threshold and a second (maximum) voltage/current threshold (larger than the first voltage/current threshold) for some threshold time duration (e.g., several milliseconds, or a longer period, as appropriate). Determining that the electrical voltage or current level is maintained for the threshold period of time can mitigate the possibility that detection of a spurious low voltage/current level would result in a transition from the protection state to the charging state, when the actual voltage/current levels that are being induced are at a dangerous level.

In some embodiments, the controller/detector (the detection circuit) 460 configured to determine that the safety charging condition is met, may be configured to receive a signal within an in-band frequency range (e.g., via the antenna 472 and the power receiver 470) used for transmitting power to the wireless power receiver 452 (e.g., via modulation of the power transfer (wireless charging) field at or near the operating frequency used for wireless power transfer), and determine that the received signal corresponds to a remote power charging device approved to charge the wireless power receiver 452. In some embodiments, the wireless charging field 434 may be modulated or regulated to cause detectable variations (e.g., time-dependent variations) of induced voltage or current corresponding to coded data symbols (an ID or some signature associated with the charging device transferring the wireless power). In such embodiments, the controller/detector 460 may be configured to determine the data symbols modulated into the wireless power transfer. The determined data symbols may then, in some embodiments, be compared to data records stored locally on a memory of the controller (or stored at a remote device) to determine if the decoded data symbol pattern matches one of those data records stored on the wireless power receiver 452. In some embodiments, the charging device 402 is configured to modulate the amplitude of power signals that the charging device 402 transmits. The modulated signals can have an amplitude that is sufficiently low so as to not affect power transmission but sufficiently high to be detected by the wireless power receiver 452. For example, the amplitude of these modulations can be between 0.1% and 10%, between 0.5% and 7%, or between any other appropriate range of the amplitude of the power signals transmitted by the charging device. The modulations can have a specific pattern that is recognizable by the chargeable device 704. Examples of differentiation features among modulation patterns include, but are not limited to, shape of the modulation pattern (e.g., square-wave, sine-wave, triangular-wave), duty cycle (e.g., percentage of “on” time versus “off” time for the modulation), frequency of the modulation, amplitude or depth of modulation, a Manchester coded modulation (e.g., allowing a series of identification bits to be transmitted, a non-zero-return (NZR) coded modulation (e.g., allowing a series of identification bits to be transmitted), and/or other suitable modulation schemes).

In some embodiments, the controller/detector (the detection circuit) 460 configured to determine that the safety charging condition is met, may be configured to receive (e.g., via an out-of-band communication transceiver, such as the transceiver 480 of FIG. 4) a radio frequency communication transmitted within a frequency range (e.g., an out-of-band range) different than a frequency range (e.g., in-band range) corresponding to the wireless medium used for wirelessly transmitting power to the receiver 452, and determine whether the radio frequency communication corresponds to a remote charging device approved to charge the wireless power receiver 452. Thus, for example, upon receiving an out-of-band communication (e.g., a BLE-based communication, a near-field communication, a WLAN-type communication, or any other type of communication), the transceiver 480 and the controller/detector 460 (which together may constitute at least part of a detection circuit) process the received communication to obtain data associated with the transmitting device (e.g., a signature, an identification value, etc.) that sent that out-of-band communication. The obtained data can then be compared against data identifying devices that have previously been approved for interaction with the wireless power receiver 452. In some embodiments, determination of whether the out-of-band communication corresponds to an approved charging device may be based on another type of authentication or verification process (e.g., using cryptographic signatures included with the out-of-band communication). If the obtained data corresponds to a previously approved charging device, or the received out-of-band communication is otherwise authenticated as having arrived from an approved charging device, the controller/detector 460 may cause the wireless power source to switch from the default protection state to a charging state, thus causing the charging circuit (e.g., the circuit 490) to operate in the charging state to power the load 492.

In some embodiments, the controller/detector 460 may cause the wireless power receiver 452 to switch from the default protection state (mode) to the charging state when multiple safety conditions are met. For example, a determination that it is safe to pull the wireless power receiver 452 from the default protection state to a charging state may be made when the condition that the voltage level (or current level) is maintained in some voltage/current range for some threshold time duration is met, and the at least further condition that either an in-band communication is received that corresponds to an approved charging device, and/or that an out-of-band communication is received that corresponds to an approved charging device. In some implementations, the two safety conditions/tests may be required to be met within some particular time period. That is, the two (or more) safety conditions do not necessarily need to be met/satisfied simultaneously, but instead should be substantially concurrent (e.g., within 1 μs, 1 ms, or some other time interval). In such embodiments, determination of a first safety condition may be verified or corroborated by ensuring that another safety condition is met. If, for instance, the controller/detector 460 determines that a voltage in the correct range is induced for at least the time duration threshold, but does not receive (substantially concomitantly) a wireless communication (through an in-band frequency range or an out-of-band frequency range) associated with a pre-approved charging device (e.g., because the voltage was induced by a charging device not compatible with the wireless power receiver 452), then the wireless power receiver 452 will remain in the default protection mode. Thus, in such embodiments, the controller/detector 460 configured to determine that the safety charging condition is met is configured to determine that a voltage level or a current level wirelessly induced at the wireless power receiver 452 is between a first (minimum) voltage threshold or a first (minimum) current threshold, and a second voltage threshold, larger than the first voltage threshold, or a second current threshold, larger than the first current threshold, for a predetermined time duration, and that at least one of: i) a signal received via a wireless medium used for transmitting power to the wireless power receiver 452 corresponds to a remote power charging device approved to charge the wireless power receiver 452, and/or ii) a radio frequency communication received within a frequency range different than a frequency band used for transmitting power to the wireless power receiver 452 corresponds to a remote charging device approved to charge the wireless power receiver 452. Other safety conditions, and/or other combinations or permutations of safety conditions, may be defined as having to be met before the wireless power receiver 452 can switch from the default protection state to a charging protection state.

When the wireless power receiver 452 is switched from the default protection state to the charging state, the controller/detector may monitor for occurrence of unsafe charging conditions (e.g., excessive induced voltage/current levels being detected), and if a determination is made that one or more unsafe charging conditions exist, the wireless power receiver 452 may be switched from operating in the charging state and placed back into the protection state (after which, the wireless power receiver 452 will be placed back into charging state if the safety conditions defined for causing the wireless power receiver 452 to switch to the charging state are met). Thus, in some embodiments, the detection circuit (which may comprise at least part of a combination of the controller/detector 460, the power receiver 470, and/or the out-of-band transceiver 480 of FIG. 4) may further be configured to determine that an unsafe charging condition is met during operation of the wireless power receiver 452 in the charging state, and produce a protect control signal in response to determining that the unsafe charging condition is met. In such embodiments, the charging circuit (e.g., such as the charging circuit 490 of FIG. 4) is configured to change from the charging state to the default protection state in response to receiving the protect control signal from the detection circuit. Changing the state of the wireless power receiver 452 may be performed manually (i.e., by a user) in response to a notification (via a user-interface coupled to the wireless power receiver 452) that one or more unsafe charging conditions have been detected, or when the user is about to enter an area with potentially large magnetic fields (e.g., in a doctor's office or a hospital).

In some situations, to avoid charging/powering the load while in the presence of a magnetic field that might be harmful to the load and/or to the wireless power receiver 452 (e.g., if the wireless power receiver 452 strays into an area where an incompatible or non-approved wireless charger is operating), the controller/detector 460 may be configured to determine if the controller/detector 460 detects (e.g., via the out-of-band communication transceiver 480) a communication signal configured according to a protocol generally associated with non-approved or incompatible charging devices. The controller/detector 460 may be configured to change the state of the wireless power receiver 452 from the charging state back to the default protection state upon detection of such a communication signal. For example, some incompatible or non-approved wireless chargers may transmit communications (in order to facilitate control of the charging/powering process with corresponding power receiver devices) configured according to a BLE protocol. Detection of BLE transmissions by the wireless power receiver 452 of FIG. 4 (assuming that the wireless power receiver 452 is configured to operate with charging devices that transmit control signals according to a different protocol and/or at different frequencies) may be indicative that the wireless power receiver 452 is in the vicinity of a charging device that may damage the wireless power receiver 452. Thus the controller/detector 460 may be configured to return the wireless power receiver 452 to protection state (mode) when the controller/detector 460 detects such transmissions.

In some embodiments, the controller/detector 460 may be configured to maintain the wireless power receiver 452 in the charging state only while the wireless power receiver continues to receive (continually or periodically) an associated control signaling (e.g., either as an in-band or out-of-band communication signal). Thus, the controller/detector 460 may be configured to cause the wireless power receiver 452 to change from operating in the charging state back to the default protection state if the controller/detector 460 detects or measures an induced voltage, but does not receive (e.g., within some threshold period of time) a communication signal to confirm that the induced voltage was caused by an approved charging device,

In some variations, power-consuming circuitry of the wireless power receiver 452 (e.g., the controller/detector 460, various power-consuming modules of the power receiver 470 and the out-of-band communication transceiver 480) may be powered by a battery that may either be the load itself (e.g., when the load 492 is a power storage device/unit) or by some other internal power storage device (not shown in FIG. 4). To avoid a “dead-battery” state (a state in which the battery used to power the active/power-consuming circuitry of the wireless power receiver 452 is at a charge level where it may not have enough of a charge to continue operation of the wireless power receiver 452), the controller/detector 460 may be configured to detect the charge level of the storage device powering the power-consuming circuitry of the wireless power receiver 452, and, if it is determined that the charge level is below some low-battery level threshold, the controller/detector 460 may disable one or more features of the wireless power receiver 452 or of modules coupled to the wireless power receiver 452. For example, for medical implants comprising wireless power receivers, the controller/detector 460 may disable some of the medical functionality of the implant device (e.g., cease nerve stimulation functionality of neuromodulation implant devices), but maintain at least partial communication functionality (e.g., so that the device may be able to re-charge when the device comes within the vicinity of a compatible charging device). While operating in the low-battery state, the wireless power receiver 452 may limit its communication to periodically reporting its low-battery condition.

The various modules of the wireless power receiver 452 may be implemented, at least in part, using switch-based circuitry (e.g., semi-conductor switching devices, such as MOSFET-based switches, BJT-based switches, etc.) to switch the wireless power receiver 452 between its various states (e.g., from a default protection state to a charging state, and vice versa). Implementations of the switch-based circuitry may be such that protection mode for the wireless power receiver 452 is the default state, without any active control (i.e., in the absence of control signals to actuate the switching devices, the wireless power receiver 452 would be in a default protection state/mode). In such implementations, in order to exit protection mode, a control signal (provided, for example, by a controller/detector module) may activate a circuit element (e.g., a switching device) configured to facilitate the transitioning between the protection and charging states (the switching device also comprises the protection mode and charging mode circuitry). In some embodiments, variable capacitors may also be used to realize the protection circuits.

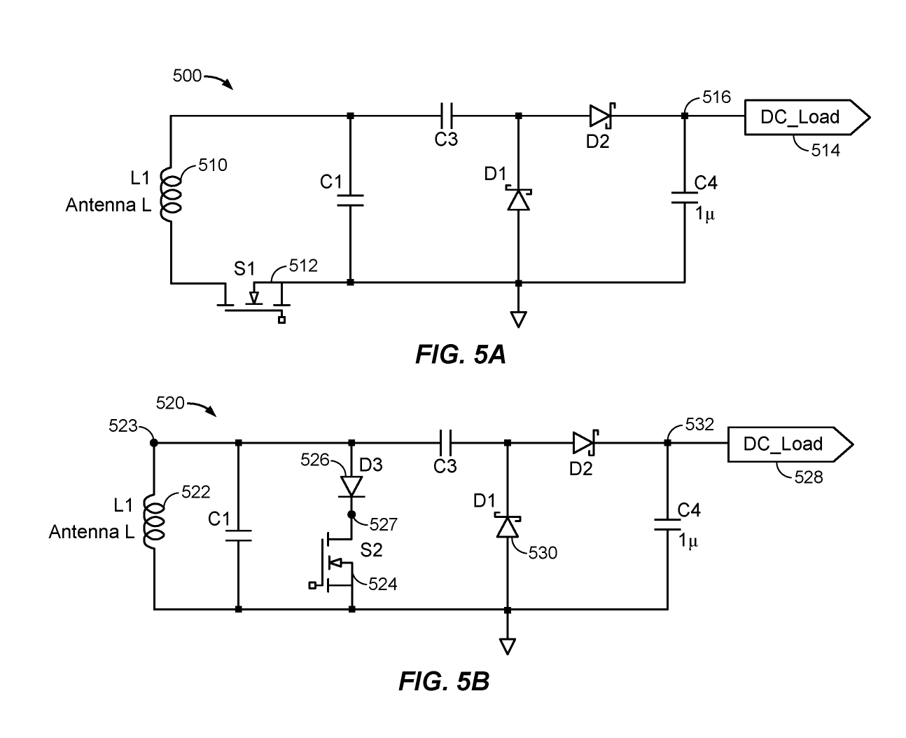

Referring also to FIG. 5A, a circuit diagram of an example circuit implementation 500 to facilitate control of state transitions for a wireless power receiver (such as the wireless power receiver 452) is shown. The circuit implementation 500 may correspond to at least some of the circuitry implementations of the controller/detector 460, the power receiver 470, the antenna 472 and the load 492 of the wireless power receiver 452. More particularly, the circuit implementation 500 includes an antenna 510 (implemented as an inductor L1 in FIG. 5A) that is electrically coupled, at one of its terminals, to a MOSFET-based switch 512 (marked as the switch S1), which may be an enhancement mode MOSFET switch (and thus, when its gate is not actuated by a control signal, would normally be in an open state). While the switch 512 is shown as a MOSFET transistor, in some embodiments, other types of switching devices (e.g., bipolar junction transistors, etc.) may be used in the implementations depicted in FIGS. 5A and 5B. The antenna 510 may correspond to the antenna 472, and the switching device 512 may be part of, for example, the controller circuitry constituting the controller/detector 460. The switching device 512 is configured to be in its open state when the wireless power receiver (comprising the circuit implementation 500) is in the default protection mode, in which case the DC output at a point 516 (that is electrically coupled to a DC Load 514, which may correspond to the load 492) is zero (0). When a charging device operates in the vicinity of the circuit implementation 500 and creates a magnetic field, a voltage or a current of a signal induced at the terminals of the antenna 510 may be sensed using, for example, a peak detector or some other voltage sensor circuit (not shown in FIG. 5A). The voltage of the induced signal can be measured and compared against a voltage threshold. The induced signal can also be processed to determine if the induced signal includes in-band signaling (e.g., a modulated signal corresponding to data such as an identifier or some predetermined signature). Upon a determination, based on the induced voltage/current at the antenna terminals, that various predetermined safety conditions are met, the switch 512 may be actuated (by a controller module) to a closed state to thus exit the default protection state and place the circuit in a charging state in which an electrical closed-circuit path to the DC load 514 is established. As noted, examples of safety conditions may include an induced voltage level within some predetermined range (which may be an adjustable range based on location of the device and/or expected distance to the charging device) associated with an approved charging device, an induced signal including a signature corresponding to an approved charging device, an out-of-band signal that includes a signature or other identifying data associated with an approved charging device, etc.

With reference also to FIG. 5B, a circuit diagram of another circuit implementation 520 to control state transitions for a wireless power receiver, and that may be used to implement at least some of the modules of the wireless power receivers described herein (e.g., the wireless power receivers 208 and 452 of FIGS. 2 and 4, respectively), is shown. The circuit implementation 520 includes an antenna 522 (which may be similar to the antenna 510 of FIG. 5A) with its terminals electrically connected in parallel to a series arrangement of a MOSFET-based switch 524 (which may be a depletion mode MOSFET switch, and thus, when its gate is not actuated by a control signal, would normally be in a closed state) and a diode 526 (marked as D3). The diode 526 is configured to prevent or inhibit the terminals of the antenna 522 from being shorted and inhibiting or preventing an induced voltage or current to be sensed (by a voltage sensing circuitry, not shown in FIG. 5B). The diode 526 may also prevent the switch 524 and a diode 530 (marked as D1 in FIG. 5B) from competing for rectification. The diode 526 has a forward voltage drop and maintains a single direction flow of current through the switch 524. Therefore, in a negative half cycle of the induced voltage, the voltage at a coupling point 527 (between one terminal of the switch 524 and one terminal of the diode 526) will have a significant magnitude to sense. The voltage can also be sensed at a terminal 523 of the antenna 522, but with a magnitude close to the forward drop of the diode. Accordingly, in the circuit implementation 520, upon a determination, based on the induced voltage/current at the antenna terminals, that various predetermined safety conditions are met (e.g., an induced voltage level is between some specified range, the induced voltage included a signature corresponding to an approved charging device, etc.), the switch 524 may be actuated to an open state, thus allowing induced voltage or current (e.g., at a point 532) to be electrically coupled to a DC load 528, and pulling the circuit implementation from a protection state into a charging (powering) state.

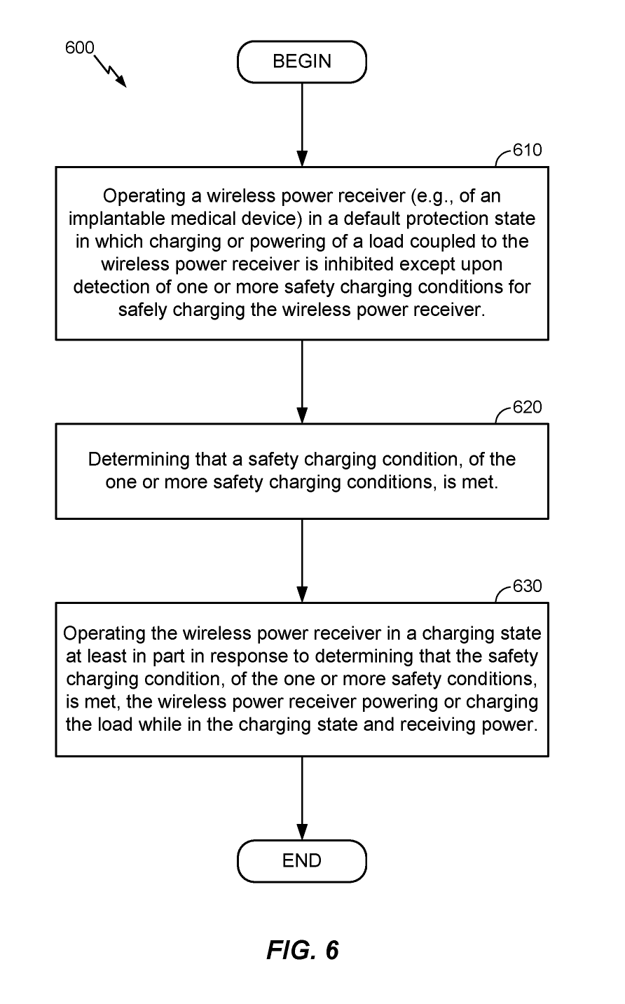

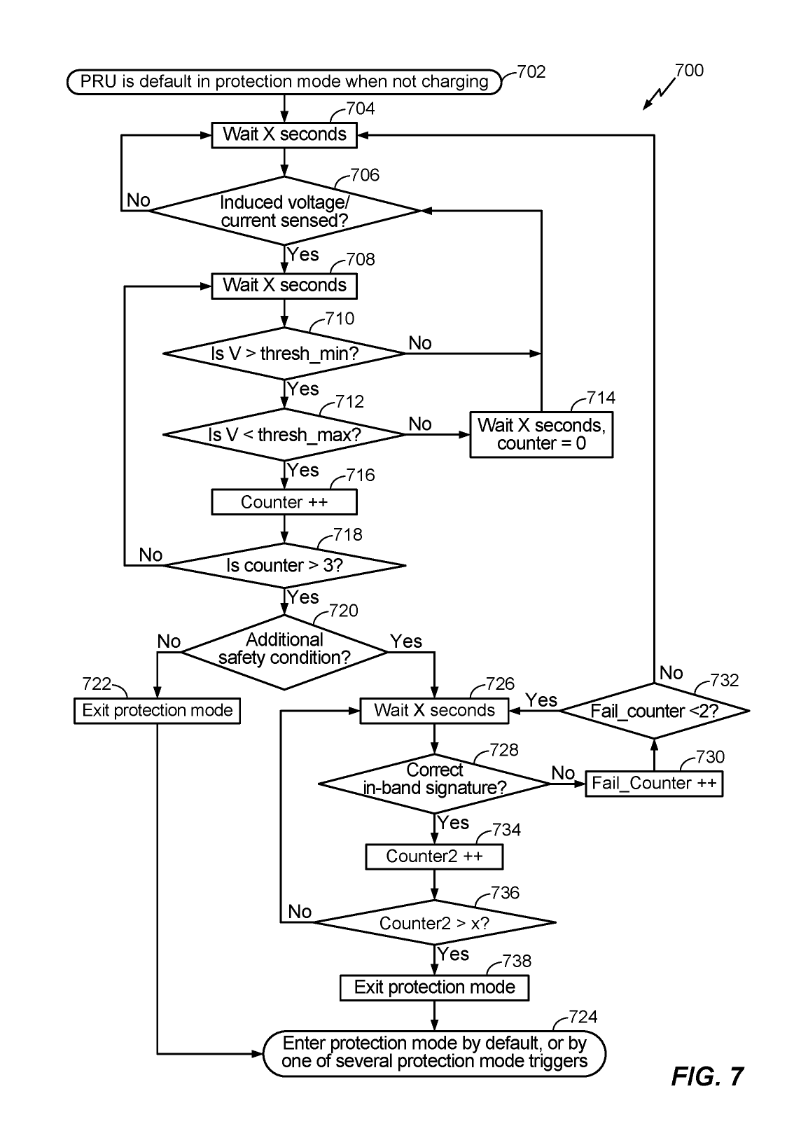

Operation of a wireless power receiver to implement the wireless power transfer, and a wireless power transfer protection mechanism, is described in relation to FIG. 6, which includes a flowchart of an example procedure 600 for wireless power transfer. At block 610, the procedure 600 includes operating a wireless power receiver (e.g., of an implantable medical device) in a default protection state in which charging or powering of a load coupled to the wireless power receiver is inhibited except upon detection of one or more safety charging conditions for safely charging the wireless power receiver. The wireless power receiver may be similar to the wireless power receivers 108, 208, and 452 depicted in FIGS. 1, 2, and 4, and may include a resonant circuit comprising a coil electrically connected to a capacitor, with the resonant circuit configured to inductively couple power via a magnetic field generated by a remote charging device (such as the transmitters 104, 204, and/or 402 of FIGS. 1, 2, and 4). In some embodiments, operating the wireless power receiver in the default protection state occurs in the absence of determining that the safety charging condition is met. Operating the wireless power receiver in the default protection state may also include operating the wireless power receiver, by default, in the default protection state and/or switching to the default protection state upon at least one of an initial activation or reset process of the wireless power receiver or a detection of an absence or termination of a wireless charging field.

Operating the wireless power receiver in the default state or in a charging state can be achieved using control devices (e.g., switching devices). In the absence of control/actuation signaling, the default operation of the control devices will cause the wireless power receiver to operate in the default protection mode. For example, in embodiments of a wireless power receiver that uses switching devices (such as the MOSFET devices of FIGS. 5A and B, or different types of switching devices) to implement control operations, when the switching devices are not actuated by control signals (generated by a controller module such as the controller/detector 460), the wireless power receiver's circuits state will be such the wireless power receiver will be operating in a default protection mode, and will not transfer power to a load connected to the wireless power receiver.

As further illustrated in FIG. 6, at block 620, the procedure 600 includes determining (e.g., by the controller/detector 460 of FIG. 4) that a safety charging condition, of the one or more safety charging conditions, is met, and, at block 630, operating the wireless power receiver in a charging state at least in part in response to determining that the safety charging condition, of the one or more safety conditions, is met, with the wireless power receiver powering or charging the load while in the charging state and receiving power. As noted, there are several pre-defined safety conditions based on which a decision to switch the wireless power receiver from default protection state to charging/powering state may be made. For example, in some embodiments, determining that the safety charging condition is met may include determining that a voltage level or current level wirelessly induced at the wireless power receiver is maintained between a first voltage/current threshold (also referred to as a minimum voltage/current threshold), and a second voltage/current threshold (also referred to as a maximum voltage/current threshold), larger than the respective first voltage/current threshold, for a threshold time duration. Alternatively, in some embodiments, the safety condition to be detected may include the voltage or current induced at the wireless power receiver being below a corresponding voltage or current threshold for some time duration (e.g., longer than some constant or adjustable time interval value, such as 1 ms or any other appropriate time value) regardless of whether the induced voltage or current exceeds some minimum voltage/current threshold. Determining whether the measured induced voltage/current is maintained at a certain level (e.g., within a specified range or below some threshold, which may be an adjustable threshold based on a changing environments and/or changing location of the power receiver) for a particular time interval mitigates the risk of switching from the default protection state to a charging/powering state based on a spurious or erroneously measured voltage/current level.

Determining that the safety charging condition is met may include receiving (by, for example, the power receiver 470 and the antenna 472) an in-band signal via a wireless medium used for transmitting power to the wireless power receiver, and determining that the received signal corresponds to a remote power charging device approved to charge the wireless power receiver. As discussed herein, the signal received may be the induced voltage or current received at a coil of the wireless power receiver used to transfer power, with that induced voltage or current being varied over time. In other words, data, such as a signature or an identifier, may be modulated onto the wireless power transferred to the wireless receiver.

In some implementations, determining that the safety charging condition is met may include receiving a radio frequency communication within a frequency range different than a frequency band used for transmitting power to the wireless power receiver (e.g., the RF frequency range is non-congruent with the in-band frequency range through which wireless power is being transferred to the wireless power receiver). The received RF communication is processed, and a determination is made of whether it corresponds to a remote charging device approved to charge the wireless power receiver, e.g., by matching an identifier included in the RF communication to a list of approved charging devices stored locally at the wireless power receive or at a remote device, cryptographically authenticating the communication, and/or otherwise confirming the identity of the remote charging device transmitting the RF communication received by the wireless device (e.g., via an out-of-band transceiver and a corresponding antenna, such as the transceiver 480 and the antenna 482 depicted in FIG. 4). Thus, in such implementations, the wireless power receives exits the default protection state if the wireless power receiver confirms that an out-of-band RF communication received by the wireless power receiver originated from an approved charging device.

Determining that the safety charging condition is met may include detecting voltage or current induced at terminals of an antenna circuit electrically coupled in series to a switching device configured to be in an open state when not actuated by a control signal such that in the default protection state there is an open electrical connection between the antenna circuit and the load. In such embodiments, the circuit configuration (also referred to as an open DC output circuit configuration) may be realized using a switching-based circuit such as the circuit implementation 500 of FIG. 5A, in which the switching device (e.g., an enhancement mode MOSFET device) is in an open (Off) state when not actuated. Alternatively, in some embodiments, the induced voltage or current may be detected by an over-voltage protection (OVP) or over-current protection (OCP) circuit configuration in which, in the default protection mode, a switching device is in a closed (ON) state when not actuated (e.g., a depletion mode MOSFET-based implementation), and causes a circuit short that prevents electrical current from reaching the load. An example of such a configuration is shown in the circuit implementation 520 of FIG. 5B.

In some implementations, operating the wireless power receiver in the default protection state comprises operating a protection circuit, configured to selectively establish an electrical path between the wireless power receiver and a load, in an open state such that an electrical path between the wireless power receiver and a load is open. In such implementations, operating the wireless power receiver in the charging state at least in part in response to determining that the safety charging condition is met may include switching the protection circuit to a closed state to close the electrical path between the wireless power receiver and the load. In some embodiments, operating the wireless power receiver in the default protection state may include operating an over voltage/current protection circuit in the default protection state, and operating the wireless power receiver in the charging state, at least in part in response to determining that the safety charging condition is met, may include de-activating the over voltage/current protection circuit (and in some embodiments, an over temperature protection (OTP) circuit) in response to determining that the safety charging condition is met.

As noted, in some implementations, two or more safety conditions may need to be met before the wireless power receiver exits its default protection state. For example, operating the wireless power receiver in the charging state in response to determining that the safety charging condition is met may include operating the wireless power receiver in the charging state in response to determining that a voltage/current level wirelessly induced at the wireless power receiver is between a first voltage/current threshold and a second voltage/current threshold (larger than the first voltage/current), and further in response to at least one of: i) determining that a signal received via a wireless medium for transmitting power to the wireless power receiver corresponds to a remote power charging device approved to charge the wireless power receiver, and/or ii) determining that a radio frequency communication received within a frequency range, different than a frequency band used for transmitting power, corresponds to the remote charging device approved to charge the wireless power receiver. As noted, in some embodiments, the two or more safety conditions/tests may be need to occur substantially concurrently (i.e., one condition is required to be met within some particular time period of the occurrence of the other condition) before the wireless power receiver can exit the default protection mode.

Referring to FIG. 7, an example procedure 700 is shown, which may be a more particular implementation of the procedure 600 of FIG. 6, and which may be realized by a wireless power receiver such as the wireless power receiver 208 and/or 452 shown in FIGS. 2 and 4. As illustrated, at the outset, the wireless power receiver (identified as a PRU in FIG. 7) is in a default protection mode (at block 702) in which the PRU inhibits charging/powering of a load to which the PRU is connected. In some implementations, while in the default protection mode, the PRU may nevertheless be configured to allow some charging if a measured voltage (or current) level is below some voltage threshold level. For example, the PRU may include an OVP (or OCP) circuit that shunts current but still allows for some level of charging to occur (e.g., charging is still allowed/enabled, but the OVP (or OCP) circuit protects voltages over a particular threshold from being applied to a downstream load charging circuitry.

In the default protection state, the PRU periodically checks for the existence of one or more safety conditions. Particularly, after waiting X seconds at block 704, the induced voltage at the PRU is measured (e.g., by a voltage sensor of the PRU) and a determination made (e.g., by a controller such as the controller/detector 460), at block 706, whether any voltage is detected (e.g., if the measured voltage exceeds some minimum level). It is to be noted that while in the example embodiment of FIG. 7 the PRU is shown to measure voltage to determine if a voltage-based safety condition is met, a similar procedure may be performed (as alternative to, or in combination with, the voltage-based measurement) with respect to a current-based safety condition (measured by a current sensor of the PRU). Detection of an induced voltage is a possible indication that a charging device (PTU) is trying to charge the load of the wireless power receive. Detection of an induced voltage may be realized using a circuit configuration such as the circuit implementation 500 or the circuit implementation 520 illustrated in FIGS. 5A and 5B, respectively. For example, in the circuit implementation 520, the diode 526 may sense voltage or current while the wireless power receiver is in a protection mode (as noted, the diode 526 is configured to sense the induced voltage or current only in half of a sinusoidal cycle of the induced voltage/current). Other voltage sensing mechanism may be used to detect an induced voltage.

If no voltage is detected (e.g., the measured voltage does not exceed a minimum voltage threshold), the procedure 700 returns to block 704 to repeat the periodic determination of whether an induced voltage is detected. If a voltage is detected (as determined at block 706), the procedure 700 waits another X seconds (or some other period of time) at block 708, and determines (optionally following another measurement independent of the measurement performed at block 706), at block 710, whether the voltage exceeds a minimum threshold (which may be different from the voltage threshold used in the initial detection at the block 706). If the voltage does not exceed the minimum threshold, the procedure 600 returns to the block 706 to continue the operations of the procedure 700. If the voltage/current exceeds the minimum threshold thresh_min (as determined at 710), a determination is next made, at block 712, whether the induced voltage is below a maximum voltage threshold (thresh_max). If the voltage does not exceed the maximum threshold, the PRU does not exit the protection state because the induced voltage may be dangerously high. Instead, the PRU waits, at block 714, for X seconds (the period of time the PRU waits for may be the same or different than the period of time illustrated with respect to the blocks 704, 708, and/or 726), and a counter, used for tracking the period of time during which the voltage are maintained within the predetermined range (e.g., between thresh_min and thresh_max) is set (or reset) to 0 (also at block 714). The procedure 700 then returns to the block 706.

If, at blocks 710, 712, the PRU (via a voltage sensor and/or a controller such as the controller/detector 460) determines that the measured induced voltage or current is within the pre-defined range, the counter, used to track the period of time during which the voltage is to be maintained at the pre-defined range, is incremented (at block 716). A determination is then made, at block 718, if the time period length at which the voltage needs to be maintained at the pre-defined range has been reached. This can be done by determining if the counter has exceeded a threshold, which, in the example of FIG. 7, has a value of 3). The use of a counter thus allows determining whether the voltage is in the desired range at four different measurement times, with consecutive measurement times separated by X seconds, which may be the same or different than the time period used in blocks 704, 708, 714, and/or 726 (it may be assumed that the voltage is relatively constant and does not spike up or down between measurement times).

If the counter exceeds the threshold (as determined at the block 718), and thus it is determined that the safety condition of the induced voltage/current has been maintained for a pre-defined period of time, a determination is made (e.g., by a controller such as the controller/detector 460), at block 720, whether an additional safety condition (in this example, a safety condition based on an in-band signal) needs to be met in order for the PRU to exit the default protection state and enter the charging state. If it is determined that no additional safety condition needs to be met (i.e., that the only condition that was to be met was that of the induced voltage/current being maintained at a pre-specified range for a threshold period of time), then the procedure 700 proceeds to block 722 where the PRU exits the default protection state (mode) and enters the charging state. It is to be noted that in implementations in which there are no additional safety conditions to be checked, the procedure 700 may not need to perform the operations of the block 720 (i.e., to determine if there is another safety condition that needs to be met). Instead, upon determining at the block 718 that the counter has exceeded a corresponding threshold (of 3, in the example of FIG. 7), the procedure 700 will proceed directly to the operation 722 (exiting protection mode) without checking to see if another condition needs to be met before exiting protection mode. Thus, in such implementations, once the condition evaluated at the block 718 is satisfied, the PRU is configured to exit protection mode.

As further illustrated in FIG. 7, the PRU is configured to return, at some later point, to the protection mode (at the block 724), in response to the safety condition(s) ceasing to be met (e.g., the induced voltage falls outside the pre-defined range), in response to a separate set of unsafe charging conditions being met, after some pre-specified period of time, or as a result of some other trigger or condition, or a combination of one or more of these. An example of an unsafe charging condition may be one in which the PRU receives a communication signal (via an out-of-band transceiver) that is associated with an incompatible or non-approved type of charging device. For example, the PRU may be configured to recognize a Bluetooth-Low-Energy™ (BLE) signal, which may be associated with incompatible charging devices, and in response to detecting a BLE signal, to exit the charging state and return to the protection state. In another example, the PRU may return to the protection state in response to determining an induced voltage or current at the wireless power receiver without also receiving an in-band communication corresponding to a remote power charging device approved to charge the wireless power receiver, or if the remote power charging device is removed, causing the induced voltage or current to drop to zero (0).

In implementations in which it is determined (at the block 720) that an additional safety condition needs to be met before the PRU may exit the default protection mode, then the PRU waits at block 726 for another X seconds (or some other period of time), and determines, at block 728, if a detected in-band signal includes a signature corresponding to an approved charging/transmitting device (the PRU may confirm or verify that the identity of the transmitting device corresponds to an approved charging device according to various processes). If the determined in-band signature does not correspond to an approved device, e.g., is not matched to an approved signature (or the verification process has otherwise failed), further attempts to confirm the in-band signature may be allowed. For example, a fail_counter is used to track the number of failed attempt to confirm the in-band signature. Thus, after determining, at the block 728 that the in-band signal does not include a correct signature (i.e., a signature corresponding to an approved device), the fail_counter is incremented at block 730. A determination is then made (e.g., by a controller such as the controller/detector 460) whether the limit of allowed attempts has been reached (in the example of the procedure 700, that limit is two). If fewer than two failed attempts have occurred, the procedure returns to the block 726. If the limit of allowed attempts has been reached, the procedure 700 returns to the block 704. Once the limit of the allowed failed verification attempts has been reached (as determined at the block 732), the PRU remains in the default protection mode, and the procedure 700 returns to the block 704 to check anew for the existence of safety conditions that would allow the PRU to exit the protection mode.

If the in-band signature is verified, the PRU, in some embodiments, will reconfirm that the correct in-band signature has been detected (with the number of times that the signature is to be verified being controlled via a second counter, Counter2). For example, after determining, at the block 728, that the correct in-band signature has been detected the Counter2 is incremented at block 734. The value of Counter2 is compared (e.g., by the controller of the PRU) to determine, at block 736, if it exceeds the minimum threshold of times that the in-band signature needs to be checked before the PRU can exit the protection mode (in the example of FIG. 7, the number of times the in-band signature needs to be checked is 2, but other values may be used). If Counter2 has not yet exceeded the threshold number of correct signature verifications, the procedure 700 returns to the block 726. If counter2 has exceeded the threshold number of correct signature verification, the PRU exits the protection state at block 738. As noted, the PRU may be configured to return, at the block 724, to the protection state (e.g., in response to the safety conditions ceasing to be met, in response a separate set of unsafe charging conditions being met, after some pre-specified period of time, or in response to some other trigger or condition, or a combination of one or more of these). The PRU is configured to wait for the occurrence of the various predetermined safety conditions, once it returns to the protection state, before leaving the protection state and transitioning to the charging state.

It will be noted that other implementations and variations of the operations of the procedure 700 depicted in FIG. 7 may be realized. For example, some of the operations depicted in FIG. 7 may be excluded (i.e., they may be optional). For instance, one or more of the counters used in the implementation of the procedure 700 may not be needed (e.g., in some implementations, the second counter, fail_counter, may not be needed if the first safety condition was met, and the correct signature was verified, thus establishing a high enough degree of confidence that the PRU can exit protection mode). In another example variation of the procedure 700, the second safety condition to be tested may be a determination of whether a correct out-of-band signature (instead of an in-band signature) was received and verified. In yet another example variation of the procedure 700, a determination that both a correct in-band signature and an out-band signature have been received and verified may be required (in addition to the voltage or current condition being met) before the PRU may exit protection mode. In a further example variation, the order in which various conditions are tested may be different than that depicted in FIG. 7. For instance, the order of tests performed in FIG. 7 may be reversed so that a determination of whether the induced voltage or current are within appropriated ranges may be performed after first determining if the correct in-band (and/or out-of-band) signature was received and verified. Many other example variations of the types and order of testing safety conditions, or other types of vatiations, may be realized with respect to the procedure 700 of FIG. 7.

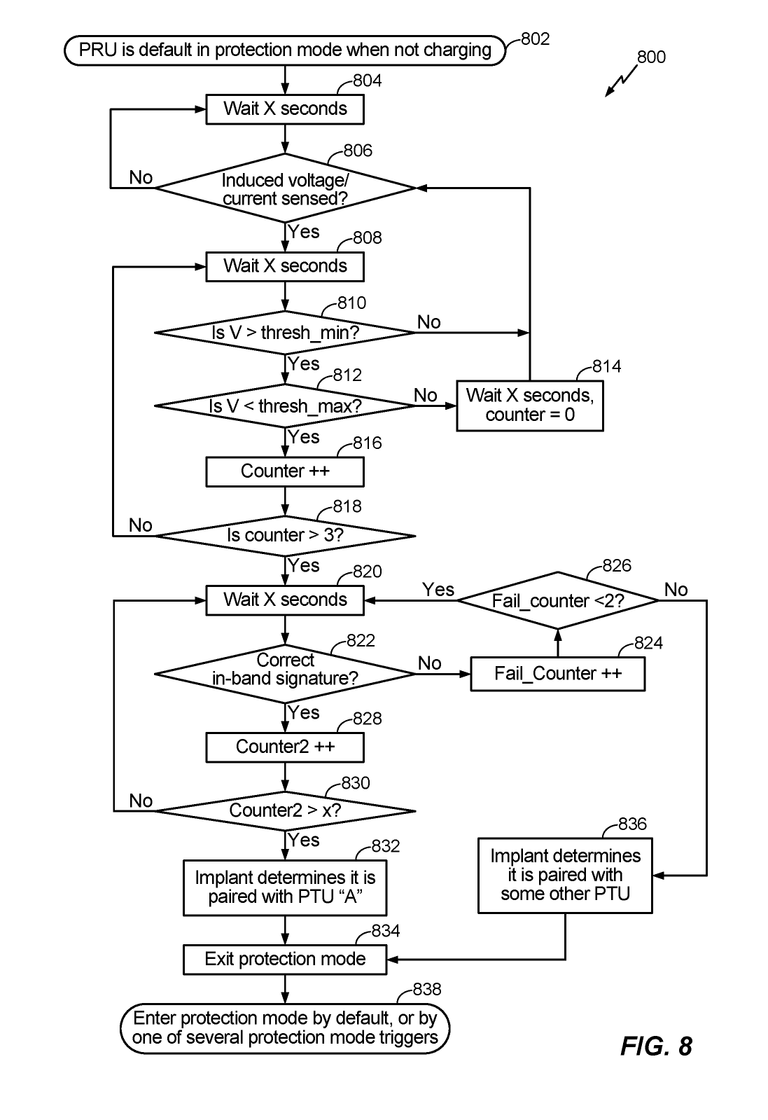

FIG. 8 is a flowchart of another example procedure 800 for wireless transfer with threshold detection and in-band signature detection that may be used to identify with which PTU a wireless power receiver is paired. The procedure 800 begins with operations to determine whether a safety condition of an induced voltage or current is within some pre-defined range (between thresh_min and thresh_max) that is maintained for a threshold period of time. The operations pertaining to the induced voltage/current detection, depicted in FIG. 8 as operations 802-818, are similar to the operations 702-718 of FIG. 7, discussed in more detail above. If it is determined that the induced voltage/current safety condition has been met (i.e., the outcome of the decision block 818 is that the induced voltage/current was within the pre-defined voltage/current range for the pre-defined period of time), the procedure 800 proceeds to block 820 where the PRU waits X seconds, and determines (e.g., by the controller of the PRU), at block 822, if a detected in-band signal includes a signature corresponding to an approved charging device (as noted, the PRU may confirm/verify that the in-band signature corresponds to an approved charging device according to various processes). If the in-band signature is confirmed to correspond to an approved charging device, the PRU may reconfirm (once, or multiple, additional instances) that the correct in-band signature has been detected (at blocks 828 and 830, using Counter2, in a manner similar to the operation described to the blocks 734 and 736 of FIG. 7), and once the in-band signature has been re-confirmed, the PRU determines at block 832 that the PRU is paired with a particular PTU (e.g., PTU “A”) and exits the protection state/mode (at block 834), at which point the PRU may charge/power the load (e.g., in accordance with the determined identity of the identified PTU; e.g., the PRU may configure adjustable elements of the charging circuitry based on the fact that PTU “A” is paired with the PRU). The PRU may subsequently return, at block 838, to the protection state (e.g., in response to the safety conditions ceasing to be met, in response a separate set of unsafe charging conditions being met, after some pre-specified period of time, based on a decision by a user of the wireless power receiver, or in response to some other trigger or condition).

If the determined in-band signature cannot be matched, at the block 822, to an approved or expected signature (or the verification process has otherwise failed), further attempts to confirm the in-band signature are performed in accordance with the value of a fail_counter (at blocks 824 and 826) to determine if the limit of allowed attempts has been reached. Once the limit of allowed failed verification attempts has been reached (as determined at the block 826), the PRU determines, at block 836, that the charging device that induced the voltage/current at the PRU corresponds to some other PTU, and proceeds to exit the protection mode. It is noted that because, in this case, the procedure 800 performed by PRU has already reached block 822, it is assumed that the PRU is interacting with a safe power charging device (i.e., a PTU causing an induced voltage or current at the PRU that are within a safe voltage/current range). The fact that the correct in-band signature has not been determined may indicate that the power charging device may not be an OEM PTU (such as the PTU “A” identified at block 832), but may nevertheless be a safe PTU. Under these circumstances the PRU can still charge, but it may have a different functionality behavior because it is now known that the PRU is not paired with its OEM PTU. The different functionality behavior may include, for example, a slower charging rate, different voltage control set points, etc. Thus, upon exiting the protection state/mode (at block 834), the PRU may charge/power the load in accordance with the fact that the PRU is interacting with a PTU other than PTU “A,” e.g., the PRU may configure adjustable elements of the charging circuitry based on the determination that the charging device with which it is paired is not PTU “A”. The PRU may subsequently return, at block 838, to the protection state (e.g., in response to the safety conditions ceasing to be met, in response a separate set of unsafe charging conditions being met, after some pre-specified period of time, based on a decision by a user of the wireless power receiver, or in response to some other trigger or condition).

Other embodiments may be implemented to control the state of a wireless power receiver based on a determination of whether one or more safety conditions have been met, including embodiments that incorporate different combinations of safety conditions to be evaluated, and different orders in which these conditions are evaluated. For example, in some embodiments, in-band signature, out-of-band communication, and induced voltage/current conditions are all checked in this order, with a subsequent condition checked only if the immediately preceding condition has been met. Other types of conditions may also be considered in evaluating whether the wireless power receiver is to exit its protection state.

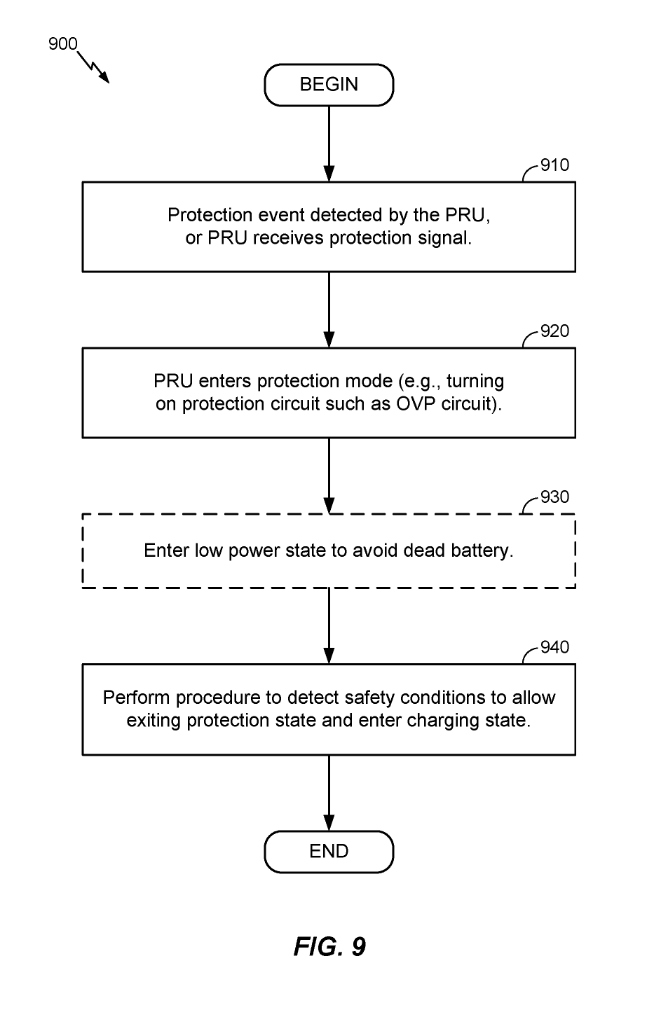

With reference now to FIG. 9, a flowchart of an example procedure 900 to switch a wireless power receiver from a charging state back to protection state is shown. While the wireless power receiver (such as the wireless power receiver 452 of FIG. 4) is operating in the charging state (e.g., as a result of operation of procedures such as 600, 700, or 800, depicted in FIGS. 6-8, respectively), the wireless power receiver detects, at block 910, a protection event (i.e., an unsafe charging condition) or receives (also at the block 910) a protection signal indicative that the wireless power receiver is to return to its protection state. As discussed herein, in some embodiments, an event corresponding to a possible dangerous magnetic field may include receipt of an RF communication associated with an incompatible or non-approved charging device. For example, some incompatible or non-approved wireless chargers may transmit communications (in order to facilitate control of the charging/powering processes for corresponding power receiver devices) configured according to a BLE protocol. Detection of BLE transmissions by the wireless power receiver 452 of FIG. 4 (assuming that the wireless power receiver 452 is configured to operate with charging devices that transmit control signals according to a different protocol and/or at different frequencies) may be indicative that the wireless power receiver 452 is in the vicinity of a charging device that may damage it, and thus the controller/detector 460 may be configured to return the wireless power receiver to the protection state (mode) when it detects such transmissions.

Upon detection of the event or signal to trigger the wireless power receiver to exit the charging state, the wireless power receiver may enter (at block 920) the protection state by, for example, causing activation of protection circuits (e.g., OVP or OCP circuits). For example, protection circuits such as the circuit implementations 500 and 520 depicted in FIGS. 5A and 5B may be activated by suspending the actuating signals applied to the switching devices 512 and 524, respectively, thus removing the electrical path between the charging circuitry and the load.

Optionally, in some embodiments, the procedure 900 may also include causing (at block 930) the wireless power receiver, and/or other units of the electronic device comprising the wireless power receiver, to enter a low power state in order to avoid a dead battery condition. In a low power state, at least some of the features of the wireless power receiver (including features that may otherwise be operational in a protection state) may be disabled in order to conserve power available from the power source used to power the wireless power receiver (the power source may be a rechargeable battery that corresponds to the load that is to be charged, or some other internal battery of the wireless power receiver). As noted, if the power source powering the wireless power receiver were to reach a dead battery state, there may not be, as a result, sufficient power to perform communication operations, to assert control signals (by the controller/detector), or to power the switching devices (such as the switching devices 512 and 524 of FIGS. 5A and 5B, respectively) used to pull the wireless power receiver from its default protection state. Generally, in a low power state, power should be provided to at least allow continued activation of communication functionality, safety condition detection, and control functionality of the protection circuitry features. Thus, in the low power state, power may be provided to at least operate one or more of the transceivers of the wireless power receiver, detect induced voltage or current, and apply control/actuation signaling. Other features of the wireless power receiver and/or other units of the electronic device (e.g., an implantable medical device) may be, at least partly, disabled (e.g., medical functionality of an implantable medical device). In some embodiments, the low power state may be entered automatically without checking for the existence of one or more conditions. In some embodiments, entering the low power state may be in response to a determination that a charge level of a storage unit (used to power the wireless power receiver) is below some threshold level (the low-battery level).

The procedure 900 also includes performing operations (at block 940) to detect safety conditions and to allow the wireless power receiver to exit the protection state and enter the charging state. The operations of the block 940 may be based, at least in part, on the operations of the procedures 600, 700, and/or 800 illustrated in FIGS. 6-8. It is also noted that, as mentioned with respect to the other procedures described herein (e.g., the procedures 600, 700, and 800), different variations of the procedure 900 may be realized. For example, the operation of the block 930 may be optional and thus may be excluded. In another example, the order at which various operations of the procedure 900 are performed may be altered.

At least some of the various illustrative blocks, modules, and circuits (including, for example, the controllers 240 and 250 of FIG. 2 and the controller/detectors 410 and 460 of FIG. 4) described in connection with the embodiments disclosed herein may be implemented or performed with a general purpose processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

If implemented in firmware and/or software, the functions may be stored as one or more instructions or code on a computer-readable medium. Examples include computer-readable media encoded with a data structure and computer-readable media encoded with a computer program. Computer-readable media includes physical computer storage media. A storage medium may be any available medium that can be accessed by a computer. By way of example, and not limitation, such computer-readable media can comprise RAM, ROM, EEPROM, CD-ROM or other optical disk storage, magnetic disk storage, semiconductor storage, or other storage devices, or any other medium that can be used to store desired program code in the form of instructions or data structures and that can be accessed by a computer; disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

Unless defined otherwise, all technical and scientific terms used herein have the same meaning as commonly or conventionally understood. As used herein, the articles “a” and “an” refer to one or to more than one (i.e., to at least one) of the grammatical object of the article. By way of example, “an element” means one element or more than one element. “About” and/or “approximately” as used herein when referring to a measurable value such as an amount, a temporal duration, and the like, encompasses variations of ±20% or ±10%, ±5%, or +0.1% from the specified value, as such variations are appropriate in the context of the systems, devices, circuits, methods, and other implementations described herein. “Substantially” as used herein when referring to a measurable value such as an amount, a temporal duration, a physical attribute (such as frequency), and the like, also encompasses variations of ±20% or ±10%, ±5%, or +0.1% from the specified value, as such variations are appropriate in the context of the systems, devices, circuits, methods, and other implementations described herein.

As used herein, including in the claims, “or” as used in a list of items prefaced by “at least one of” or “one or more of” indicates a disjunctive list such that, for example, a list of “at least one of A, B, or C” means A or B or C or AB or AC or BC or ABC (i.e., A and B and C), or combinations with more than one feature (e.g., AA, AAB, ABBC, etc.). Also, as used herein, unless otherwise stated, a statement that a function or operation is “based on” an item or condition means that the function or operation is based on the stated item or condition and may be based on one or more items and/or conditions in addition to the stated item or condition.

Although particular embodiments have been disclosed herein in detail, this has been done by way of example for purposes of illustration only, and is not intended to be limiting with respect to the scope of the appended claims, which follow. In particular, it is contemplated that various substitutions, alterations, and modifications may be made without departing from the spirit and scope of the invention as defined by the claims. Other aspects, advantages, and modifications are considered to be within the scope of the following claims. The claims presented are representative of the embodiments and features disclosed herein. Other unclaimed embodiments and features are also contemplated. Accordingly, other embodiments are within the scope of the following claims.

What is claimed is:

1. A method for wireless power transfer, the method comprising:
operating a wireless power receiver in a default protection state in which charging or powering of a load coupled to the wireless power receiver is inhibited except upon detection of one or more safety charging conditions for safely charging the wireless power receiver;
determining that a safety charging condition, of the one or more safety charging conditions, is met; and
operating the wireless power receiver in a charging state at least in part in response to determining that the safety charging condition, of the one or more safety conditions, is met, the wireless power receiver powering or charging the load while in the charging state and receiving power.

2. The method of claim 1, wherein determining that the safety charging condition is met comprises determining that a voltage level or a current level wirelessly induced at the wireless power receiver is maintained between a first voltage threshold or a first current threshold and a second voltage threshold, larger than the first voltage threshold, or a second current threshold, larger than the first current threshold, for a threshold time duration.

3. The method of claim 1, wherein determining that the safety charging condition is met comprises determining that a voltage level or a current level wirelessly induced at the wireless power receiver is maintained below a voltage threshold or a current threshold for a threshold time duration.

4. The method of claim 1, wherein determining that the safety charging condition is met comprises:
receiving a signal via a wireless medium used for transmitting power to the wireless power receiver; and
determining that the received signal corresponds to a remote power charging device approved to charge the wireless power receiver.

5. The method of claim 1, wherein determining that the safety charging condition is met comprises:
receiving a radio frequency communication within a frequency range different than a frequency band used for transmitting power to the wireless power receiver; and
determining that the radio frequency communication corresponds to a remote charging device approved to charge the wireless power receiver.

6. The method of claim 1, wherein operating the wireless power receiver in the charging state in response to determining that the safety charging condition is met comprises:
operating the wireless power receiver in the charging state in response to determining that a voltage level or a current level wirelessly induced at the wireless power receiver is between a first voltage threshold or a first current threshold, and a second voltage threshold, larger than the first voltage threshold, or a second current threshold, larger than the first current threshold, and further in response to at least one of: i) determining that a signal received via a wireless medium for transmitting power to the wireless power receiver corresponds to a remote power charging device approved to charge the wireless power receiver, or ii) determining that an radio frequency communication received within a frequency range, different than a frequency band used for transmitting power, corresponds to the remote charging device approved to charge the wireless power receiver.

7. The method of claim 1, further comprising changing from operating the wireless power receiver in the charging state to operating the wireless power receiver in the default protection state in response to determining that an unsafe charging condition is met.

8. The method of claim 7, wherein the wireless power receiver is changed from operating in the charging state to operating in the default protection state in response to receiving a communication signal associated with a charging device that is incompatible with the wireless power receiver.

9. The method of claim 8, wherein the communication comprises a Bluetooth-Low-Energy™ (BLE) communication.

10. The method of claim 7, wherein the wireless power receiver is changed from operating in the charging state to operating in the default protection state in response to determining an induced voltage or current at the wireless power receiver without receiving an in-band communication corresponding to a remote power charging device approved to charge the wireless power receiver.

11. The method of claim 1, further comprising:
determining a charge level of a power storage unit of the wireless power receiver; and
disabling one or more features of the wireless power receiver operating in the default protection state in response to determining that the charge level of the power storage unit is below a low-battery level.

12. The method of claim 1, wherein operating the wireless power receiver in the default protection state occurs in the absence of determining that the safety charging condition is met.

13. The method of claim 1, wherein operating the wireless power receiver in the default protection state comprises operating the wireless power receiver, by default, in the default protection state or switching to the default protection state upon at least one of an initial activation or reset process of the wireless power receiver or a detection of an absence or termination of a wireless charging field.

14. The method of claim 1, wherein determining that the safety charging condition is met comprises:
detecting voltage or current induced at terminals of an antenna circuit electrically coupled in series to a switching device configured to be in an open state when not actuated by a control signal such that in the default protection state there is an open electrical connection between the antenna circuit and the load.

15. The method of claim 1, wherein operating the wireless power receiver in the default protection state comprises operating an over voltage protection circuit or over current protection circuit in the default protection state;
and wherein operating the wireless power receiver in the charging state at least in part in response to determining that the safety charging condition is met comprises de-activating the over voltage protection circuit or the over current protection circuit in response to determining that the safety charging condition is met.

16. The method of claim 1, wherein operating the wireless power receiver in the default protection state comprises operating a protection circuit, configured to selectively establish an electrical path between the wireless power receiver and the load, in an open state, while the wireless power receiver is in the default protection state, such that the electrical path between the wireless power receiver and the load is open;
and wherein operating the wireless power receiver in the charging state at least in part in response to determining that the safety charging condition is met comprises switching the protection circuit to a closed state to close the electrical path between the wireless power receiver and the load.

17. A wireless power receiver comprising:
a detection circuit configured to determine that a safety charging condition is met and to produce a charge control signal in response to determining that the safety charging condition is met; and
a charging circuit, communicatively coupled to the detection circuit and to a load, and configured to power or charge the load using wirelessly transferred power, the charging circuit configured to operate in a charging state in response to receiving the charge control signal, and in the absence of receiving the charge control signal to operate in a default protection state in which powering or charging of the load is inhibited.

18. The wireless power receiver of claim 17, wherein to determine that the safety charging condition is met, the detection circuit is configured to determine that a voltage level or a current level wirelessly induced at the wireless power receiver is between a first voltage threshold or a first current threshold, and a second voltage threshold, larger than the first voltage threshold, or a second current threshold, larger than the first current threshold, for a threshold time duration.

19. The wireless power receiver of claim 17, wherein to determine that the safety charging condition is met, the detection circuit is configured to determine that a voltage level or a current level wirelessly induced at the wireless power receiver is maintained below a voltage threshold or a current threshold for a threshold time duration.

20. The wireless power receiver of claim 17, wherein to determine that the safety charging condition is met, the detection circuit is configured to:
receive a signal via a wireless medium used for transmitting power to the wireless power receiver; and
determine that the received signal corresponds to a remote power charging device approved to charge the wireless power receiver.

21. The wireless power receiver of claim 17, wherein to determine that the safety charging condition is met, the detection circuit is configured to:
receive a radio frequency communication within a frequency range different than a frequency band used for transmitting power to the wireless power receiver; and
determine that the radio frequency communication corresponds to a remote charging device approved to charge the wireless power receiver.

22. The wireless power receiver of claim 17, wherein to determine that the safety charging condition is met, the detection circuit is configured to determine that a voltage level or a current level wirelessly induced at the wireless power receiver is between a minimum voltage threshold or a minimum current threshold, and a maximum voltage threshold or a maximum current threshold, for a threshold time duration, and that at least one of: i) a signal received via a wireless medium used for transmitting power to the wireless power receiver corresponds to a remote power charging device approved to charge the wireless power receiver, or ii) a radio frequency communication received within a frequency range, different than a frequency band used for transmitting power to the wireless power receiver, corresponds to the remote charging device approved to charge the wireless power receiver.

23. The wireless power receiver of claim 17, wherein the detection circuit is further configured to:
determine that an unsafe charging condition is met during operation of the wireless power receiver in the charging state; and
produce a protect control signal in response to determining that the unsafe charging condition is met;
wherein the charging circuit is configured to change from the charging state to the default protection state in response to receiving the protect control signal from the detection circuit.

24. The wireless power receiver of claim 17, wherein the charging circuit comprises a switching device electrically coupled in series to an antenna of the wireless power receiver, the switching device configured to be in an open state when not actuated by the charge control signal such that in the default protection state there is an open electrical connection between the antenna and the load, the switching device further configured to be closed upon application of the charge control signal such that an electrical connection between the antenna and the load is established.

25. The wireless power receiver of claim 17, wherein the charging circuit comprises an arrangement of a switching device coupled to a diode, with the arrangement electrically coupled in a parallel configuration to terminals of an antenna of the wireless power receiver, the switching device configured to be in a closed state when not actuated by the charge control signal such that in the default protection state the antenna is periodically electrically shorted.

26. The wireless power receiver of claim 17, wherein the charging circuit comprises a resonant circuit comprising a coil electrically connected to a capacitor, the resonant circuit configured to inductively couple power via a magnetic field generated by a remote charging device.

27. The wireless power receiver of claim 17, wherein the detection circuit is further configured to:
determine a charge level of a power storage unit of the wireless power receiver; and
produce a disable control signal in response to determining that the charge level of the power storage unit is below a low-battery level to disable one or more features of the wireless power receiver.

28. An apparatus for wireless power transfer, the apparatus comprising:
means for operating a wireless power receiver in a default protection state in which charging or powering of a load coupled to the wireless power receiver is inhibited except upon detection of one or more safety charging conditions for safely charging the wireless power receiver;
means for determining that a safety charging condition, of the one or more safety charging conditions, is met; and
means for operating the wireless power receiver in a charging state at least in part in response to determining that the safety charging condition, of the one or more safety conditions, is met, the wireless power receiver powering or charging the load while in the charging state and receiving power.

29. The apparatus of claim 28, wherein the means for determining that the safety charging condition is met comprises means for determining that a voltage level or a current level wirelessly induced at the wireless power receiver is maintained between a minimum voltage threshold or a minimum current threshold, and a maximum voltage threshold or a maximum current threshold for a pre-defined time duration.

30. A non-transitory computer readable media programmed with instructions, executable on a processor, to:
operate a wireless power receiver in a default protection state in which charging or powering of a load coupled to the wireless power receiver is inhibited except upon detection of one or more safety charging conditions for safely charging the wireless power receiver;
determine that a safety charging condition, of the one or more safety charging conditions, is met; and
operate the wireless power receiver in a charging state at least in part in response to determining that the safety charging condition, of the one or more safety conditions, is met, the wireless power receiver powering or charging the load while in the charging state and receiving power.
